(19) United States
(12) Patent Application Publication
(10) Pub. No.: US 2010/0301798 A1
(43) Pub. Date: Dec. 2, 2010

(54) METHOD FOR CONTROLLING SOLAR CHARGE DEVICE AND PORTABLE TERMINAL USING THE SAME

(75) Inventors: Yoon Soon CHANG, Jeollabuk-do (KR); Young Seo JUNG, Gyeongsangbuk-do (KR); Seung Ha LEE, Daegu (KR); Chang Min LEE, Ulsan (KR); Hee Jung CHOI, Gwangju (KR)

Correspondence Address: Cha & Reiter, LLC, 17 Arcadian Avenue, Suite 208, Paramus, NJ, 07652, US

(73) Assignee: SAMSUNG ELECTRONICS CO., LTD., Gyeonggi-Do (KR)

(21) Appl. No.: 12/788,445

(22) Filed: May 27, 2010

(30) Foreign Application Priority Data
May 28, 2009 (KR) 10-2009-0047013

(51) Int. Cl. H01M 10/46

(52) U.S. Cl. 320/101

(57) ABSTRACT

A method for controlling a solar charge device and a portable terminal using the same by registering a driver software for controlling the solar charge device in an operating system. Upon booting of the portable terminal, and enabling the charge detection terminal every set given time period stored in the driver software after the booting completion, a charge detection signal corresponding to presence of power output of a solar cell being input to the charge detection terminal. The method and the portable terminal prevent the occurrence of lock-up in the portable terminal due to frequent interrupts occurring in the charge detection terminal from a non-uniform output of a solar cell that may occur as movement of the portable terminal can vary the amount of sunlight received by the solar cell.

### CLAIM OF PRIORITY

This application claims the benefit of priority under 35 U.S.C. §119(a) from a Korean patent application filed in the Korean Intellectual Property Office on May 28, 2009 and assigned Serial No. 10-2009-0047013, and the entire disclosure of which is hereby incorporated by reference.

### BACKGROUND OF THE INVENTION

1. Field of the Invention

The present invention relates to a method for controlling a solar charge device and a portable terminal using the same. More particularly, the present invention relates to the occurrence of lock-up in solar charge devices that interrupts charging and causes a non-uniform output of a solar cell.

2. Description of the Related Art

In general, a method using solar energy is divided into a methods using solar heat and a methods using photons. The method using solar heat heats water using the solar heat to perform heating or power generation. The method using photons operates by converting the photons into electricity to operate all kinds of machines and tools. Since the method using solar energy permits generation of power based on an unlimited pollution-free solar energy source (the Sun), it has an advantage that electricity can be obtained wherever there is sunshine. Further, the method has an additional advantage that pollution, such as atmospheric contamination, noise, generation of heat, and vibration does not occur.

Meanwhile, with the development of mobile communication technology, a portable terminal has quickly become one of modern life's necessities. Such portable terminals often provide various optional functions such as an MP3 function, mobile broadcasting receiving function, moving image reproduction function, and camera function. By providing the various optional functions to portable terminals, an amount of a time that a user operates the portable terminal for purposes other than voice communication (e.g., listening to music, games and the like) has rapidly increased. Accordingly, there is a need for an increase in the capacity of a battery, particularly those used in portable terminals. However, there is a limitation in the increase in a capacity of a battery due to the physical characteristics of the portable terminal. In recent years, a portable terminal capable of charging the battery using solar energy has been developed. Such a portable terminal can include a solar cell converting solar energy into electrical energy. However, the solar cell has a disadvantage in that an output voltage is non-uniform because the varying amounts of sunlight cause variance in an intensity of photons. Owing to the foregoing problem, in a conventional portable terminal, frequent interrupts can occur in a charge detection terminal sensing presence of charging. When the frequent interrupts occur, the conventional portable terminal has a disadvantage in that lock-up occurs, affecting operability of the device.

### SUMMARY OF THE INVENTION

The present invention provides a method for controlling a solar charge device capable of preventing the occurrence of lock-up due to frequent interrupts occurring from a non-uniform output voltage of a solar cell, and a portable terminal using the same.

In accordance with an exemplary aspect of the present invention, a portable terminal including a solar charge device for charging a battery using solar energy preferably includes: a storage unit which is configured to store a driver software which is registered in an operating system and is used to control the solar charge device; a solar cell which converts received solar energy into electrical energy; a charging unit which is configured to receive the electrical energy from the solar cell to charge the battery, and to generate a charge detection signal when the electrical signal is input from the solar cell; a controller which is configured to comprise a charge detection terminal receiving the charge detection signal, to generate a charge control signal for controlling an activation of the charging unit and to transfer the charge control signal to the charging unit, wherein the charge detection terminal is enabled every given time period stored in the driver software.

In accordance with another exemplary aspect of the present invention, a method for controlling a solar charge device of a portable terminal charging a battery using solar energy includes: registering a driver software for controlling the solar charge device in an operating system upon booting of the portable terminal; enabling a charge detection terminal for inputting a charge detection signal corresponding to an output of power of a solar cell according to every set given time period stored in the driver software after the booting completion; and charging the battery when the charge detection signal is input during an enable time period of the charge detection terminal.

### BRIEF DESCRIPTION OF THE DRAWINGS

The above and other exemplary aspects, features, and advantages of certain exemplary embodiments of the present invention will become more apparent from the following description taken in conjunction with the accompanying drawings, in which:

FIG. 1 is a block diagram schematically illustrating a configuration of a portable terminal according to an exemplary embodiment of the present invention;

FIG. 2 is a graphical illustration of an input voltage and a detection signal of a charging unit according to an exemplary embodiment of the present invention;

FIG. 3 is a flowchart illustrating a method for controlling a solar charge device according to an exemplary embodiment of the present invention;

FIG. 4 is a view illustrating the variations in charging states of a solar charge device according to an exemplary embodiment of the present invention; and

FIG. 5 is a graph illustrating control signals associated with various charging states in a portable terminal according to an exemplary embodiment of the present invention.

### DETAILED DESCRIPTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring appreciation of the subject matter of the present invention by a person of ordinary skill in the art.

In the present specification, a person of ordinary skill in the art should understand and appreciate that the following disclosure is provided for exemplary purposes only and is not intended as a limitation of the presently claimed invention. Furthermore, all alternate embodiments which are modifications of this disclosure are intended to be encompassed within the scope of the presently claimed invention.

Prior to the description of the present invention, for convenience of the description, the device portrayed according to an exemplary embodiment of the present invention is a portable terminal capable of charging a battery using a solar cell. However, the portable terminal portrayed herein is not a limitation of the presently claimed invention, as the presently claimed invention is applicable to all kinds of information and communication devices and multi-media devices such as, for example, Navigation terminals, digital broadcasting terminals, Personal Digital Assistants (PDA), Smart Phones, Portable Multimedia Player (PMP) terminals, International Mobile Telecommunication 2000 (IMT-2000) terminals, Code Division Multiple Access (CDMA) terminals, Wideband Code Division Multiple Access (WCDMA) terminals, Global System for Mobile communication (GSM) terminals, Universal Mobile Telecommunication Service (UMTS) terminals, note book computers, Netbook computers, and applications thereof, just to name of few of the virtually endless list of possible devices.

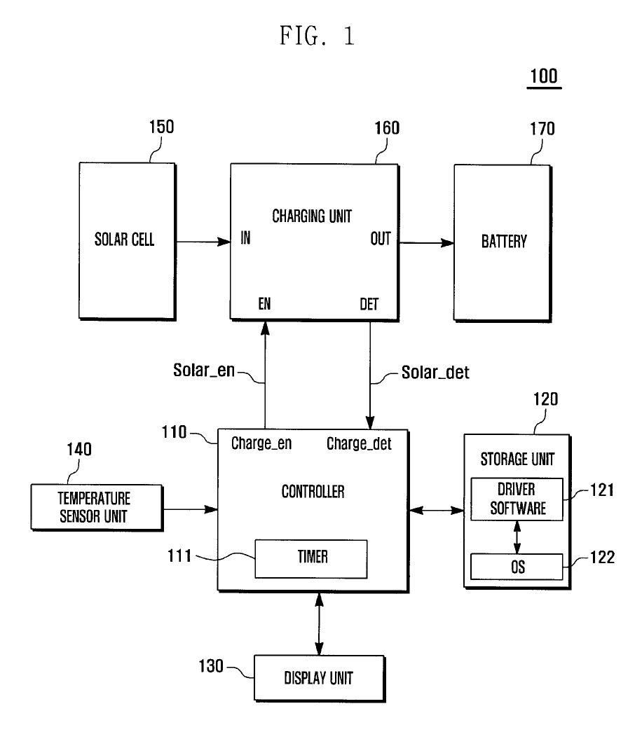

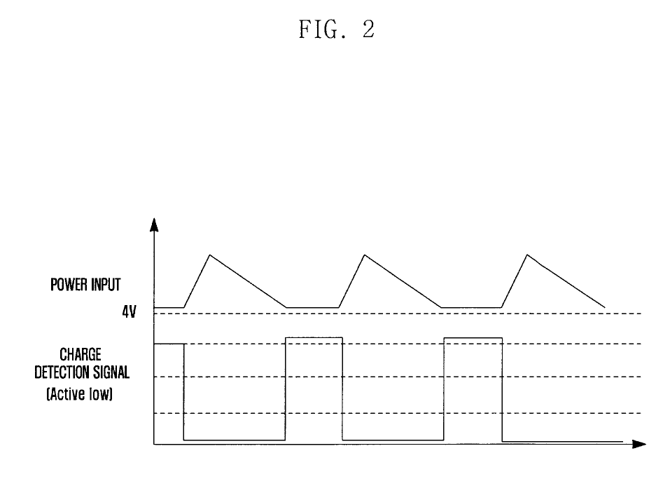

FIG. 1 is a block diagram schematically illustrating a configuration of a portable terminal 100 according to an exemplary embodiment of the present invention, and FIG. 2 is a graphical illustration of an input voltage and a charge detection signal based on the input voltage of a charging unit according to an exemplary embodiment of the present invention.

Referring now to FIG. 1 and FIG. 2, the portable terminal 100 according to an exemplary embodiment of the present invention may preferably include a controller 110, a storage unit 120, a display unit 130, a temperature sensor unit 140, a solar cell 150, a charging unit 160, and a battery 170.

The solar cell 150 preferably converts solar energy into electrical energy. The solar cell 150 can be classified into one of a solar cell using solar thermal electricity or a photovoltaic solar cell using photons. Here, the photovoltaic solar cell is simply described as an example of the solar cell. The photovoltaic solar cell is achieved by providing a P-N junction diode. The photovoltaic solar cell is made based on photovoltaic energy conversion in which electrons are asymmetrically arranged in a semiconductor structure. For example, an n-type zone in the P-N junction diode has a large electron density and small hole density, whereas a p-type zone therein has small electron density and large hole density. Accordingly, charge disproportion occurs in a diode formed by junction between a P-type semiconductor and an N-type semiconductor in a thermal equilibrium state by diffusion due to a density distribution of a carrier. This disproportion produces an electrical field, so that the carrier is not diffused any longer. When light having energy greater than band gap energy is applied to the P-N junction diode, electrons are excited from a valence band of a material to a conduction band. In this case, the band gap energy refers to an energy difference between the conduction band and the valence band. The electrons excited in the conduction band may freely move, and holes are produced in positions of the valence band from which electrons are discharged. Excessive produced carriers are diffused into the conduction band or the valence band due to a density difference. The flow of existing main carriers present in the P-type semiconductor or the N-type semiconductor is hindered due to an energy barrier occurring by an electrical field during a diffusion procedure, but auxiliary carriers produced due to diffusion may be moved to a different type of a semiconductor. As a result, carriers move during the diffusion procedure to break a charge balance in a natural state. This causes a voltage difference and accordingly electromotive force is produced in a positive electrode of the P-N junction diode. The solar cell 150 can be configured by a plurality of solar cells converting solar energy into electrical energy connected to each other in series or parallel. The solar cell 150 may be formed semi-transparently or opaquely according to its manufacturing method. The solar cell 150 of the present invention is disposed at a body of the portable terminal 100. When the solar cell 150 is disposed at a cover of the portable terminal, the solar cell can be semi-transparently or opaquely made. When the solar cell 150 is disposed at the display unit 130 of the portable terminal, the solar cell may be transparently made. Output power of the solar cell 150 is transferred to the charging unit 160 to be used for charging the battery 170 of the portable terminal 100.

Still referring to FIG. 1, the charging unit 160 may receive the power from the solar cell 150 in order to charge the battery 170. The charging unit 160 includes an input terminal IN receiving the electrical energy from the solar cell 150, an output terminal OUT transferring the electrical energy to the battery 170, an enable terminal EN receiving a charge control signal Solar_en for activating or deactivating a charge function, and a detection terminal DET for detecting power input from the solar cell 150 and for transferring a detection signal to the controller 110. The charging unit 160, according to an exemplary embodiment of the present invention, may be an active-low type that is activated upon input of a low signal to the enable terminal EN. However, the present invention is not limited thereto. Namely, the present invention may use an active-high type charging unit 160 that is activated upon input of a high signal to the enable terminal EN. When the charging unit 160 is the active low type, the enable terminal EN of the charging unit 160 may include a pull-down resistor for preventing a floating state. In particular, when the charging unit 160 according to the present invention detects power input from the solar cell 150, the charging unit 160 may transfer a charge detection signal Solar_det to the controller 110 through the detection terminal DET. When the power input from the solar cell 150 is not detected, the charging unit 160 may transfer a high signal to the controller 110 as the charge detection signal Solar_det. When the power input from the solar cell 150 is detected, the charging unit 160 may change the charge detection signal Solar_det to a low signal, and transfer the low signal to the controller 110.

Referring now to FIG. 2, the power input to the charging unit 160 may be non-uniform and irregular as shown in FIG. 2. Namely, only when an output voltage of the solar cell 150 is greater than a voltage of the battery 170, power can be input to the charging unit 160. Accordingly, the charge detection signal ‘Solar_det’ output from the detection terminal DET of the charging unit 160 can change from a high signal to a low signal. The exemplary embodiment of the present invention has been described in that the charge detection signal Solar_det is the low signal upon detection of the power input but the charge detection signal is the high signal when the power input is not detected. However, the present invention is not limited thereto. In other words, the charge detection signal Solar_det may be the high signal upon detection of the power input but the charge detection signal Solar_det may be the low signal when the power input is not detected.

The battery 170 preferably comprises a secondary battery for charging and can be made in various forms such as a lithium ion battery, a nickel battery, a cadmium battery, a nickel-cadmium battery, or a chemical battery. The battery 170 may be charged by the charging unit 160 and provide power to respective structural elements of the portable terminal 100.

The temperature sensor unit 140 preferably detects a temperature. It is preferred that the temperature sensor unit 140 is mounted in the vicinity of the battery 170 if possible in order to exactly detect the temperature of the battery 170. A reason why the temperature sensor unit 140 detects the temperature of the battery 170 is because there is danger such as an explosion when the battery 170 is charged at too high of a temperature. A thermistor may be used as the temperature sensor unit 140. In this case, resistance of the thermistor varies according to a temperature.

The display unit 130 may output screen data created during a function execution of the portable terminal 100 and status information according to a user's key operation and function setting. Further, the display unit 130 may visually display various signals and color information outputted from the controller 110. The display unit 130 can be configured by a liquid crystal display (LCD) or an organic light-emitting diode (OLED). In addition, any type of thin-film screen technology or an equivalent thereof, can be used. When the display unit 130 is implemented in a touch screen type, it may perform as an input unit (not shown) with the additional function of receiving inputs from a user. The display unit 130 may output images which are set differently according to a charged state (charging execution state, charging suspended state, or discharging state) under the control of the controller 110. The images can be output on an indicator region on which icons indicating antenna receiver sensitivity, morning call setting, and the like are displayed.

The charged state of the portable terminal 100 may preferably include a charging suspended state, a discharging state, and a charging execution state. The charging execution state means a state that the battery 170 is being charged through the solar cell 150. The discharging state means a state that the battery 170 is discharged through the solar cell, for example, photons are interrupted. The charging suspended state means a state that the controller 110 suspends charging of the battery 170 because a higher temperature state greater than a first set reference temperature, or a lower temperature state less than a second set reference temperature is sensed although there are photons. This charging suspended state prevents damage of the battery 170 due to charging at the higher than or lower than temperature.

With reference again to FIG. 1, the storage unit 120 may store programs necessary to execute an overall operation and specific functions of the portable terminal 100, and data created during execution of the programs. Namely, the storage unit 120 may store an operating system (OS) 122 booting the portable terminal 100, application programs necessary for functional operations of the portable terminal 100, and data created according to the use of the portable terminal 100. The storage unit 120 may be configured by a read only memory (ROM) and a random access memory (RAM). In particular, the storage unit 120 according to the present invention may store a driver software 121 for controlling the solar charge device. The driver software 121 can be stored in a callback function pattern. The driver software 121 may be registered in the OS 122 upon booting of the portable terminal 100.

The controller 110 may perform overall control functions of the portable terminal 100 and control signal flows between respective blocks in the portable terminal 100. In particular, the controller 110 according to an exemplary embodiment of the present invention may execute an Interrupt Service Routine (ISR) according to the occurrence of respective interrupts with reference to the driver software 121 stored in the storage unit 120.

The controller 110 may control activation of the charging unit 160. For example, when the battery 170 is being charged through an external charger (e.g., TA), the controller 110 deactivates the charging unit 160, thereby stopping charging (and possible over-charging) of the battery 170 by the solar cell 150. To stop the charging, the controller 110 may include an interrupt terminal (not shown) recognizing insertion of the external charger. When the higher temperature state or the lower temperature state is sensed, the controller 110 deactivates the charging unit 160 to stop the charging of the battery 170 using the solar cell 150. To deactivate the charging unit 160, the controller 110 may receive the temperature of the battery 170 from the temperature sensor unit 140.

The controller 110 may preferably include a charge detection terminal ‘Charge_det’ receiving the charge detection signal ‘Solar_det’ from the charging unit 160. The charge detection terminal Charge_det may be activated every time period stored in the driver software 121. Namely, when the charge detection terminal Charge_det is deactivated, the controller 110 does not recognize the input of the charge detection signal ‘Solar_det’. When the charge detection terminal Charge_det is always enabled, the controller 110 may receive frequent interrupts due to non-uniform output power of the solar cell 150. In this case, lock-up of the portable terminal 100 can occur. One reason to enable the charge detection terminal Charge_det for a given time period is to prevent the lock-up of the portable terminal 100 from occurring. To enable the charge detection terminal Charge_det, the controller 110 may include a timer 111 counting a first time period disabling the charge detection terminal Charge_det and a second time period enabling the charge detection terminal Charge_det.

When the display unit 130 is turned-off, namely, when the display is in a sleep state, the controller 110 may stop the timer 111 and change the charge detection terminal Charge_det to a disabled state. Here, the sleep state refers to a state that stops all functions except for necessary functions to minimize the power consumption of the battery. In other words, the controller 110 may disable the charge detection terminal Charge_det in the sleep state in order to reduce power consumption of the battery. Next, when the display unit 130 is turned-on, the controller 110 may enable the charge detection terminal Charge_det and control the timer 111 to count the second time period.

When the charge detection signal Solar_det is input during an enable time period of the charge detection terminal Charge_det, the controller 110 may activate the charging unit 160 and execute the ISR outputting an image indicating the activation of the charging unit 160 on the display unit 130. At this time, when the higher temperature state or the lower temperature state is sensed, the controller 110 may deactivate the charging unit 160 to be in the charging suspended state.

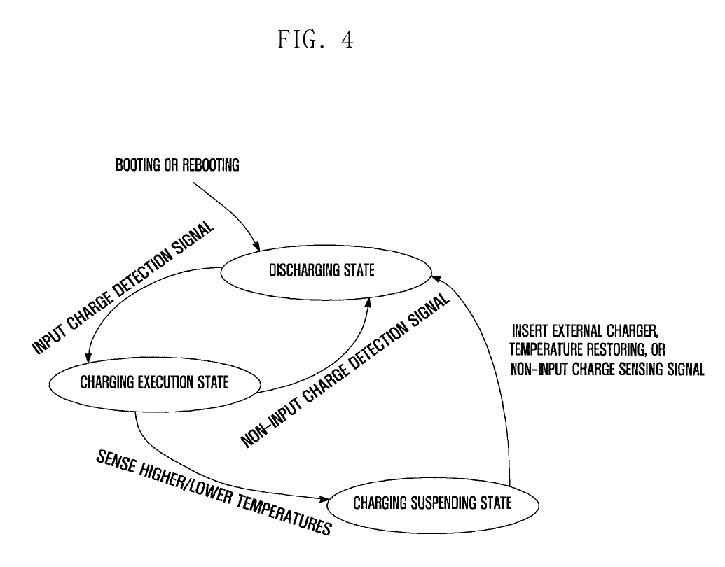

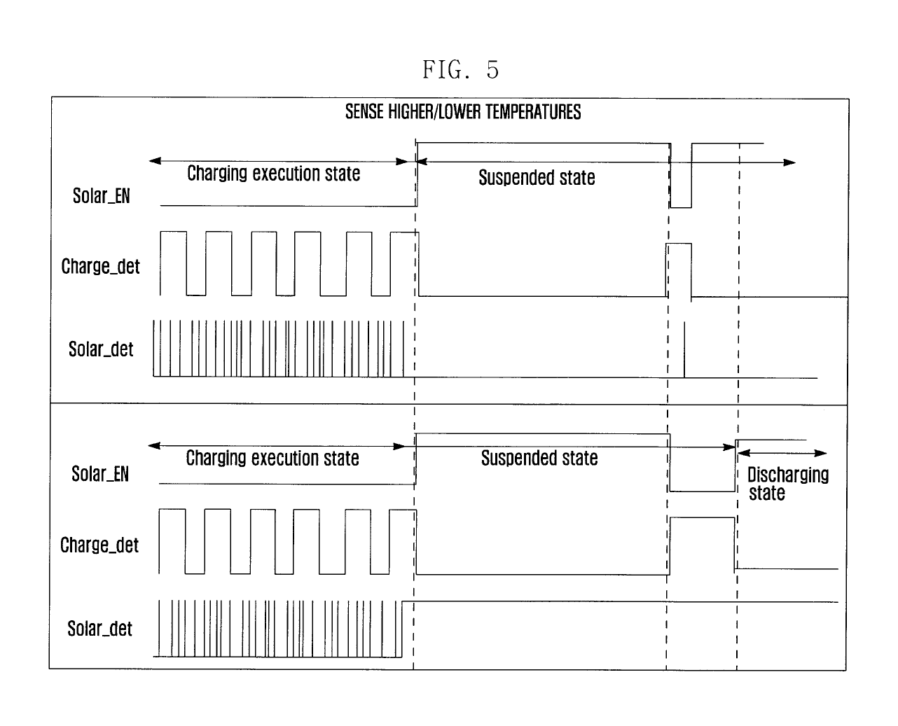

The controller 110 may recognize a charged state and display a corresponding image on the display unit 130. As described above, the charged state may include a charging suspended state, a discharging state, and a charging execution state. When the controller 110 does not receive the charge detection signal Solar_det from the charging unit 160, the controller 110 may determine that the charging unit 160 is in the discharging state. When the controller 110 receives the charge detection signal Solar_det from the charging unit 160, the controller 110 may determine that the charging unit 160 is in the charging execution state. When the higher temperature state or the lower temperature is sensed in the charging execution state, the controller 100 may change the charging unit 160 to the charging suspended state. A charging state change of the portable terminal 100 will now be described with reference to FIGS. 4 and 5 below.

Although they are not expressly shown in the drawings, the portable terminal 100 may selectively include structural elements having additional functions, such as a camera module photographing images or moving images, a near field communication module for near field communication, a broadcasting receiving module for broadcasting reception, a digital sound source module including an MP3 module, and an Internet communication module communicating with Internet to perform an Internet function, just to name a few possibilities. In the convergence trend of digital devices, since variations and modifications of the structural elements are very various, not all structural elements are listed. However, the portable terminal 100 according to the present invention may further include structural elements equivalent to the level of foregoing structural elements.

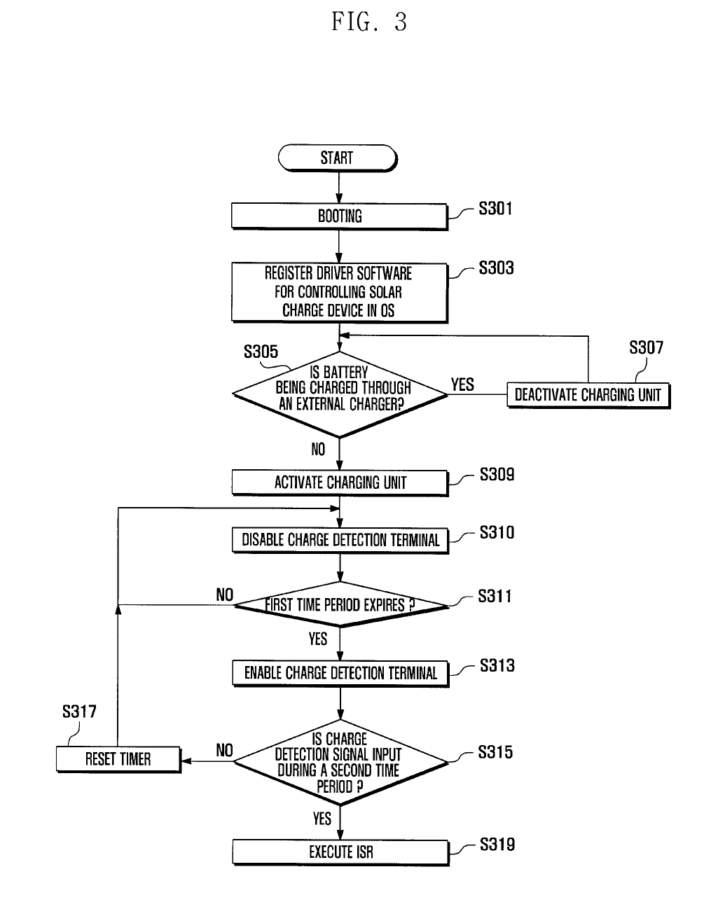

FIG. 3 is a flowchart illustrating a method for controlling a solar charge device according to an exemplary embodiment of the present invention.

Referring to FIGS. 1 to 3, at step (S301), the controller 110 performs a booting procedure. At step (S303), the controller 110 may register a driver software 121 for controlling the solar charge device in an OS 122 during the booting procedure. The driver software 121 can be stored in a callback function pattern. At this time, the controller 110 may transfer a charge control signal Solar_en for deactivating the charging unit 160 to an enable terminal EN of the charging unit 160 to control the portable terminal to be in a discharging state.

After completion of booting, at step (S305), the controller 110 can determine whether or not a battery 170 is being charged through an external charger (e.g., TA). To make such a determination regarding charging, the controller 110 may include an interrupt terminal (not shown) for recognizing insertion of the external charger. When the battery 170 is being charged through the external charger at step S305, at step (S307) the controller 110 may deactivate the charging unit 160. To deactivate the charging unit, the controller 110 may transfer the charge control signal Solar_en to the enable terminal EN of the charging unit 160 through a charge control terminal Charge_en. In this case, the charge control signal Solar_en may be a high signal (e.g. logical high).

On the other hand, when the battery 170 is not being charged through the external charger at step S305, at step (S309), the controller 110 may activate the charging unit 160. To activate the charging unit, when the charging unit 160 is an active-low type, the controller 110 may transfer a low signal to the enable terminal EN of the charging unit 160 through a charge control terminal Charge_en. When the charging unit 160 is activated, at step (S310), the controller 110 may disable the charge detection terminal Charge_det. In this case, although the charge detection signal Solar_det is input to the charge detection terminal Charge_det, the controller 110 cannot recognize the signal.

Subsequently, at step (S311) the controller 110 may check whether a first time period, being a disable time period of the charge detection terminal Charge_det, expires. When the first time period has not expired, the controller 110 may return to step S310. On the other hand, at step (S313), when the first time period has expired, the controller 110 may enable the charge detection terminal Charge_det.

Then, at step (S315), the controller 110 may check whether the charge detection signal Solar_det is inputted during a second time period being an enable time period of the charge detection terminal Charge_det. When the charge detection signal Solar_det is not input, at step (S317) the controller 110 resets the timer 111. Then, the routine returns to step S310 and the foregoing steps are repeated.

On the other hand, when the charge detection signal Solar_det is input, at step (S319), the controller 110 calls the driver software 121 and executes a set Interrupt Service Routine (ISR). For example, the controller 110 may control the display unit 130 to display an image corresponding to a charged state thereon.

FIG. 4 is a view illustrating a charged state change of a solar charge device according to an exemplary embodiment of the present invention, and FIG. 5 is a graph illustrating control signals by charged states in a portable terminal according to an exemplary embodiment of the present invention.

Referring now to FIGS. 1 to 5, the portable terminal 100 can be set in a discharging state at the time of booting or rebooting. When the charge detection signal Solar_det is input during an enable time period of the charge detection terminal Charge_det, the state of the portable terminal 100 can be changed to a charging execution state.

Next, when the charge detection signal Solar_det is not input during the enable time period of the charge detection terminal Charge_det, the state of the portable terminal 100 can be changed to a discharging state.

Conversely, when a higher temperature state or a lower temperature state is sensed in the charged state, the state of the portable terminal 100 can be changed to a charging suspended state. The charging suspended state is a state in which power is input to the charging unit 160 to be charged but the controller 110 deactivates the charging unit 160 in order to prevent damage of the battery 170 caused by charging in the higher temperature state or the lower temperature state.

Subsequently, when an external charger (TA) is recognized in the charging suspended state, or a temperature is restored to a room temperature ranging from the lower temperature to the higher temperature, the portable terminal 100 may be changed to the discharging state.

As shown in FIG. 5, when the charge detection signal Solar_det is input during the enable time period of the charge detection terminal Charge_det, the controller 110 determines that charging is possible because there are photons, and the portable terminal 100 may maintain the charging suspended state.

Conversely, when the charge detection signal Solar_det is not input during the enable time period of the charge detection terminal Charge_det, the controller 110 determines that there are no photons, and the portable terminal 100 can be changed to a discharging state. The controller 110 can update an image indicating a charged state of the portable terminal 100 during a given time period when the display unit 130 is turned-on.

Moreover, when the display unit 130 is changed from the on-state to the off-state, the controller 110 may control the image to be updated. In addition, the portable terminal 100 according to the present invention can provide different application programs according to its charged state. For example, the portable terminal 100 can display different background screens according to its charged state.

The above-described methods according to the present invention can be realized in hardware or as software or computer code that can be stored in a recording medium such as a CD ROM, a RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

As is clear from the forgoing description, in the method for controlling a solar charge device and the portable terminal using the same, lock-up of a portable terminal due to frequent interrupt occurrence of the solar charge device can be prevented.

What is claimed is:

1. A portable terminal comprising a solar charge device for charging a battery using solar energy, the portable terminal comprising:
a storage unit comprising a machine readable medium which is configured to store machine executable code comprising a driver software which is registered in an operating system and is used to control the solar charge device;
a solar cell which converts received solar energy into electrical energy;
a charging unit which is configured to receive the electrical energy from the solar cell for charging the battery, and to generate a charge detection signal when the electrical signal is input from the solar cell; and
a controller which is configured to comprise a charge detection terminal for receiving the charge detection signal, to generate a charge control signal for controlling an activation of the charging unit, and to transfer the charge control signal to the charging unit,
wherein the charge detection terminal is enabled in every given time period stored in the driver software.

2. The portable terminal of claim 1, wherein the controller comprises:
a timer which counts a first time period for disabling recognition, by the controller, of an input from the charge detection terminal and a second time period for enabling recognition, by the controller, of an input from the charge detection terminal, and
the controller activates the charging unit for charging when the charge detection signal is input to the controller during the second time period, and deactivates the charging unit to interrupt the charging of the charging unit when the charge detection signal is not input during the second time period.

3. The portable terminal of claim 1, further comprising a temperature sensor unit for detecting a temperature.

4. The portable terminal according to claim 3, wherein the temperature sensor unit comprises a thermistor.

5. The portable terminal of claim 3, wherein the controller deactivates the charging unit to interrupt the charging of the charging unit when a higher temperature state greater than a first set reference temperature, or a lower temperature state less than a second set reference temperature, is detected by the temperature sensor unit.

6. The portable terminal of claim 2, further comprising: a display unit for outputting one or more visual indications corresponding to a charged status of the portable terminal comprising a charging execution state indicating that the battery is being charged, a discharging state indicating that power is not output from the solar cell, and a charging suspended state indicating that the power is output from the solar cell and the charging unit is deactivated.

7. The portable terminal of claim 6, wherein the controller changes the charged status of the portable terminal to the discharging state when the charge detection signal is not input during the second time period, changes the charged state of the portable terminal to the charging execution state when the charge detection signal is input during the second time period, and changes the charged state of the portable terminal when the higher temperature state or the lower temperature state is sensed in the charge execution state.

8. The portable terminal of claim 7, wherein the controller controls a change of the charged state of the charging unit to the discharging state when at least one event occurs that comprises: recognition of an external charger in the charging suspended state, non-sensing of the higher temperature state or the lower temperature state, and non-input of the charge detection signal during the second time period.

9. The portable terminal of claim 6, wherein the controller stops the timer and puts the charge detection terminal in a disabled state when the display unit is in a sleep state, and wherein the controller enables the charge detection terminal and activates the timer when the display unit is not in the sleep state.

10. The portable terminal of claim 6, wherein the controller controls the visual indication corresponding to the charged state to be updated when the display unit changes from an off-state to an on-state, and controls the image to be updated every set given time period when the display unit is in the on state.

11. A method for controlling a solar charge device of a portable terminal charging a battery using solar energy, the method comprising
registering a driver software for controlling the solar charge device in an operating system upon booting of the portable terminal;
enabling a charge detection terminal for receiving a charge detection signal corresponding to an output of power of a solar cell according to every set given time period stored in the driver software after the booting completion; and
charging the battery when the charge detection signal is input during an enable time period of the charge detection terminal.

12. The method of claim 11, further comprising:
detecting a temperature in proximity to the battery.

13. The method of claim 12, further comprising:
stopping charging of the battery when detecting a higher temperature state is greater than a first set reference temperature, or a lower temperature state is less than a second set reference.

14. The method of claim 12, wherein the temperature is detected by a temperature sensing unit.

15. The method of claim 14, wherein the temperature sensing unit comprises a thermistor.

16. The method of claim 11, further comprising:
checking a charged state of the portable terminal comprising at least one of: a charging execution state indicating that the battery is being charged, a discharging state indicating that power is not being output from the solar cell, and a charging suspended state indicating that the power is output from the solar cell and the charging unit is deactivated, using the output power of the solar cell; and
outputting a visual indication corresponding to the charged state of the portable terminal.

17. The method of claim 16, wherein checking a charged state of the portable terminal comprises:
determining the charged state to be the discharging state when the charge detection signal is not input during the enable time period of the charge detection terminal;
determining the charged state to be the charging execution state when the charge detection signal is input during the enable time period of the charge detection terminal; and
determining the charged state to be the charging suspended state when a higher temperature state or a lower temperature state is detected in the charging execution state.

18. The method of claim 17, wherein checking a charged state of the portable terminal comprises:
changing the charged state of the portable terminal to the discharging state when an external charger is recognized in the charging suspended state;
changing the charged state of the portable terminal to the discharging state when the higher temperature state or the lower temperature state is detected in the charging execution state; and
changing the charged state of the portable terminal to the discharging state when the charge detections signal is not input, and maintaining the charging suspended state when the charge detection signal is input during the enable time period of the charge detection terminal in the charging suspended state.
